(19) United States
(12) Patent Application Publication
(10) Pub. No.: US 2011/0037561 A1
(43) Pub. Date: Feb. 17, 2011

(54) TRANSCODER APPARATUS AND METHODS

(75) Inventors: Paul LeeRoy True, Merlin, OR (US); Justin Garrett Hopper, Grants Pass, OR (US); Chris Reed Murphy, Grants Pass, OR (US); Ammon Joseph Carpenter, Grants Pass, OR (US)

Correspondence Address: Silicon Forest Patent Group;Paul J. Fordenbacher, 11876 NW Tyler Ct, Portland, OR, 97229, US

(73) Assignee: LINX TECHNOLOGIES, INC., Merlin, OR (US)

(21) Appl. No.: 12/668,660

(22) PCT Filed: Aug. 13, 2008
(86) PCT No.: PCT/US08/73083

§ 371 Date: Jun. 23, 2010

Related U.S. Application Data
(60) Provisional application No. 60/955,627, filed on Aug. 13, 2007.

(51) Int. Cl. G06F 7/04

(52) U.S. Cl. 340/5.7

(57) ABSTRACT

Embodiments of methods, systems and devices including encoders and decoders are disclosed.

### RELATED APPLICATIONS

This application is a PCT patent application claiming priority to U.S. provisional patent application No. 60/955,627, filed on Aug. 13, 2007, which is in its entirety incorporated herewith by reference, and is a continuation-in-part application to PCT application PCT/US2007/080007, international filing date Sep. 28, 2007, which is in its entirety incorporated herewith by reference, which itself claims benefit to U.S. provisional patent application No. 60/827,653, filed on Sep. 29, 2006, which is in its entirety incorporated herewith by reference, and U.S. provisional patent application No. 60/829,144, filed on Oct. 11, 2006, which is in its entirety incorporated herewith by reference.

### FIELD

Embodiments presented herein relate to encoders and decoders apparatus and methods.

### BACKGROUND

Wireless remote control devices based on radio frequency (RF) or infrared (IR) communication are growing in popularity and finding their way into more applications. Remote Keyless Entry (RKE) systems are known in the art for operating locks and accessories on cars, operating garage doors, and activating building alarms. The idea behind wireless remote control is simple: a button press or contact closure on a transmitter product causes some action to be taken at a receiver product.

Traditionally, a remote control link has operated in only one direction, from the transmitter product to the receiver product.

Recent advances have resulted in the development of integrated circuit (IC) devices called encoders and decoders. Encoders, which are found in the transmitter product, record the status of inputs, usually button or contact closures, as binary data and combine it with a unique identifier, forming an encoded data packet. The encoded data packet is communicated via a transmitted signal such that only decoders provided with the correct means are able to decode and validate the information contained in the transmitted data packet. Upon successful recovery and validation, the decoder output lines are set to replicate the states of the encoder data lines. These decoder output lines can then be used to control the application circuitry.

Current wireless remote control devices operate as one-way communication devices. That is, the transmitter product communicates a command signal to a receiver product, but the transmitter product is not operable to receive communications from the receiver product. A significant limitation due to this one-way communication is that the transmitter product is unable to determine whether the receiver product has received the transmission from the transmitter. Further, the transmitter product is unable to determine whether the receiver product has properly interpreted the transmission from the transmitter.

What is needed in the art is a device that combines a remote control encoder and decoder into a single device. Such a device, referred to as a transcoder, would be capable of sending commands as well as receiving them.

### SUMMARY

In accordance with an embodiment, an apparatus operable to function as an encoder and decoder.

In accordance with an embodiment, a transcoder operable to function as an encoder and decoder, the transcoder comprising one or more status I/O lines, the transcoder being operable to set an address by randomizing a number based on a time that a status I/O line is held in a predetermined state.

In accordance with an embodiment, a transcoder operable to function as an encoder and decoder, the transcoder comprising one or more status I/O lines, the direction of the status I/O lines being dynamically programmable.

In accordance with an embodiment, a transcoder operable to function as an encoder and decoder operable to learn an address of another transcoder.

In accordance with an embodiment, a transcoder operable to function as an encoder and decoder operable to store a list of authorized users.

In accordance with an embodiment, a transcoder operable to function as an encoder and decoder operable to store a set of control permissions for each user.

In accordance with an embodiment, a transcoder operable to function as an encoder and decoder operable for affecting an automatic confirmation transmission in response to a command transmission.

In accordance with an embodiment, a transcoder operable to function as an encoder and decoder, the transcoder comprising one or more status line inputs and status line outputs, the transcoder operable to store latched or momentary status line outputs based on a state of an input.

In accordance with an embodiment, a transcoder operable to function as an encoder and decoder, the transcoder comprising one or more status line inputs and status line outputs, the transcoder operable to set individual output lines as latched or momentary based on a mask set by a user and stored in memory on the transcoder.

In accordance with an embodiment, a transcoder operable to function as an encoder and decoder, the transcoder operable to have a selectable baud rate.

In accordance with an embodiment, a transcoder operable to function as an encoder and decoder, the transcoder comprising one or more status line inputs and status line outputs, the transcoder operable to output an identification of the transcoder.

In accordance with an embodiment, a transcoder operable to function as an encoder and decoder, the transcoder comprising one or more status line inputs and status line outputs, the transcoder operable to toggle a transceiver between transmit and receive functionality.

In accordance with an embodiment, a transcoder operable to function as an encoder and decoder, the transcoder comprising one or more status line inputs and status line outputs, the transcoder operable to control power to a transceiver.

In accordance with an embodiment, a transcoder operable to function as an encoder and decoder, the transcoder comprising one or more status line inputs and status line outputs, the transcoder operable to target another transcoder so that only a targeted transcoder will respond to a command transmission.

In accordance with an embodiment, a transcoder operable to function as an encoder and decoder, the transcoder comprising one or more status line inputs and status line outputs, the transcoder operable to send custom, user defined data.

In accordance with an embodiment, a transcoder operable to function as an encoder and decoder, the transcoder comprising a serial programming interface.

In accordance with an embodiment, a transcoder operable to function as an encoder and decoder, the transcoder comprising one or more status line inputs and status line outputs, the transcoder operable to be programmed using a single wire interface.

In accordance with an embodiment, a transcoder operable to function as an encoder and decoder, the transcoder comprising one or more status line inputs and status line outputs, the transcoder including a single wire interface operable to use hardware flow-control (RTS, CTS).

In accordance with an embodiment, a transcoder operable to function as an encoder and decoder, the transcoder comprising one or more status line inputs and status line outputs, the transcoder operable to accept all valid transmissions in one mode of operation or to accept only valid transmissions from authorized sources in another mode of operation.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the method comprising: recording the electrical state of first status I/O lines that are programmed to be status line inputs as binary data; combining the binary data with a unique identifier to form a command data packet; encoding the command data packet for security such that only another transcoder that is provided with a correct means is able to decode and validate the binary data contained in the command data packet; and programming status I/O lines to be status line outputs on the second transcoder product that are set to replicate the electrical state of the status line inputs on the first transcoder product upon successful recovery and validation of the binary data from the command data packet.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the method comprising: creating an address including reading a current address stored in memory on the transcoder; running a randomizing algorithm for a time that an input is held in a first state; and writing to transcoder memory the resulting address when the input is held in a second state.

In accordance with an embodiment, a method of operating a transcoder operable to function as an encoder and decoder, the transcoder comprising one or more status I/O lines, a data transmission I/O line, the transcoder being operable to generate a command data packet representative of electrical states of the status line inputs, the method comprising: causing the transcoder to make all of the status I/O lines as status line inputs; starting a timeout timer; reading the logic states of the status line inputs by the transcoder; updating the assignment of the status I/O line to make that status I/O line a status line input if a status line input is held in a first state; continuing to monitor the status I/O lines by the transcoder until the timeout timer expires; and writing an assignment to memory on the transcoder.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the method comprising: associating the transcoder with another transcoder by holding an input in a first state on the receiving transcoder to place it into a special learn mode; sending a command data packet comprising an address associated with the sending transcoder from the transmitting transcoder and received by the receiving transcoder; and storing the received address in memory on the receiving transcoder.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the method comprising: pulling a transceiver control line referred to as the TR_PDN line to a first state to activate an external transceiver; starting a timer in the transcoder;

checking the logic state of one of its input lines, referred to as the CRT/LRN line; saving the received address in memory if the CRT/LRN line is held in a first state; check for valid packets by the transcoder if the CRT/LRN line is held in a second state; checking to see if the timeout timer has expired by the transcoder if there are no valid packets; checking to see if the packet is intended for a specific transcoder by the transcoder if there are valid packets; checking to see if the target address matches its local address by the transcoder if the packet is targeted; checking to see if the target address matches its local address by the transcoder if the target address does not match; checking to see if the timeout timer has expired; saving and updating the control permissions if the target address matches or if the packet is not targeted; checking to see if the automatic confirmation is enabled and, if so, pulling a transceiver control line referred to as the TR_SEL line to a first state to place an external transceiver into transmit mode; making the TR_DATA line an output so that it can send data packets to the transceiver; outputting a confirmation packet on the TR_DATA line; pulling the TR_SEL line to a second state to place the transceiver into receive mode; making the TR_DATA line an input so that it can receive data from the transceiver; checking to see if the timeout timer has expired; looping back to check if the CRT/LRN line is in the first state if not; saving the received address in memory if the timeout timer has expired; and saving by the transcoder all activated status lines as the control permissions.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the method of setting a serial interface comprising: making an input line, referred to as the SER_IO line, an input; receiving a serial command by the transcoder; pulling an output line, referred to as the MODE_IND line, to a first state to indicate that the SER_IO line is an output and will send data if a valid command is received; making the SER_IO line an output and pulling the line to the first state; processing the command by the transcoder, either reading data from memory or writing data to memory; sending by the transcoder an acknowledgement and a reply, if required by the command; pulling by the transcoder the MODE_IND line to a second state; and making the SER_IO line an input.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the method comprising: activating the TR_PDN line on the transcoder to turn on a transceiver prior to sending a command; activating the TR_SEL line on the transcoder to turn the transceiver into the functionality of a transmitter; and deactivating the TR_PDN line and the TR_SEL line if the procedure is complete.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the method comprising: supplying power to the transceiver; turning the transceiver into the functionality of a receiver; looking for valid data for a predetermined period of time; and powering down for a predetermined period of time.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the method comprising: pulling the TR_SEL line to a second state to place the transceiver into receive mode initializing transceiver control; making the TR_DATA line an input so that it can get data from the transceiver; checking an ON Timer to see if the timer has expired; checking the transcoder input lines to see if the transcoder should go into a specific mode of operation if the ON timer has not expired; pulling the TR_PDN line to the second state to deactivate the transceiver if the ON timer has expired; setting an OFF Timer and enter sleep; waking up and setting the ON timer when the OFF timer expires; pulling the TR_PDN line to a first state to reactivate the transceiver; and checking the transcoder input lines to see if the transcoder should go into a specific mode of operation until the ON timer expires.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the method comprising: setting status line outputs either as momentary or latched, wherein with momentary outputs, the transcoder activates the outputs only for as long as valid data packets are received instructing the transcoder to activate them, and once the data packets stop and the transcoder times out, the output lines are deactivated, and wherein with latched outputs, the transcoder activates the outputs upon reception of a valid data packet and holds them in a first state until the data packet is received a second time, at which point the transcoder deactivates them.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the transcoder in electrical communication with a transceiver, the method of sending a transmission comprising: pulling a TR_PDN line to a first state to turn on the transceiver; pulling a TR_SEL line to a first state to place the transceiver into transmit mode; making a TR_DATA line an output so that it can send data to the transceiver; checking, by the transcoder, the logic state of the status line inputs; creating the command byte; reading, by the transcoder, the local address, target address, and custom data value from memory; assembling the data packet consisting of a preamble, a local Address, and a Command Byte; adding, by the transcoder, the target address to the data packet if targeting is enabled; checking to see if custom data is enabled if targeting is not enabled; adding, by the transcoder, the custom data value to the data packet if custom data is enabled; outputting the data packet on the TR_DATA line if custom data is not enabled; pulling, by the transcoder, the TR_SEL line to a second state to place the transceiver into receive mode; making the TR_DATA line an input; starting a timer; waiting in a loop, by the transcoder, until either the timer times out or a valid confirmation data packet is received; pulling, by the transcoder, the TR_SEL line to a first state to place the transceiver into transmit mode and making the TR_DATA line an output so that it can send data to the transceiver when the timer times out; checking, by the transcoder, to see if any status line inputs are in the first state; getting, by the transcoder, the command byte and starting the loop again if any status line inputs are in the first state; exiting the mode if no status line inputs are high; pulling, by the transcoder, the TR_SEL line to the first state to place the transceiver into transmit mode and making the TR_DATA line an output so that it can send data to the transceiver if a valid confirmation packet is received; pulling, but the transcoder, the CONFIRM line to the first state, resetting the timer, and checking to see if any status line inputs are high if the confirmation is valid; getting the command byte and starting the loop again if any status line inputs are in the first state; and exiting the mode if no status line inputs are in the first state.

In accordance with an embodiment, a method of operating a transcoder operable to function as an encoder and decoder, the transcoder comprising one or more status line inputs, one or more status line outputs, a data transmission I/O line, the transcoder being operable to generate a command data packet representative of electrical states of the status line inputs, the transcoder in electrical communication with a transceiver, the method of sending a transmission comprising: looking, by the transcoder, for any valid data packets; checking, by the transcoder, to see if a RX Mode timer has timed out if no valid data packets are received; checking, by the transcoder, to see if the transcoder is in Open Reception mode if the transcoder receives valid data packets; skipping checking to see if the address is authorized if the transcoder is in Open Reception mode; checking to see if the received address is in memory on the transcoder and is authorized to activate the transcoder if the transcoder is not in Open Reception mode; checking to see if a RX Mode timer has timed out if the address is not authorized; checking to see if received data packet is a targeted packet intended for a specific transcoder; checking to see if a transcoder local address matches a target address in a received data packet if the data packet is targeted; checking to see if the RX Mode timer has timed out if the received target address does not match the local address; making a SER_IO line an output and pulling it to a first state if the received data packet is not targeted, or if the local address matches the target address; performing a logical AND operation with the Command Byte and the Control Permissions to get the Control Byte, thereby removing the activations of any status lines that are not authorized for control by the transmitting transcoder; performing a logical AND operation between the received Command Byte and the I/O Assignment to get the Output Byte; outputting the Output Byte on the status lines if Latch mode is not enabled; performing a logical XOR (exclusive OR) operation on the Output Byte and the current logical states of the status line outputs if Latch mode is enabled; outputting the resulting Output Byte on the status line outputs; outputting the received address, the received Command Byte, and any received custom data on the SER_IO line if the transcoder is in Open Reception mode; outputting the transmitting transcoder ID, the received Command Byte, and any received custom data on the SER_IO line if the transcoder is not in Open

Reception mode; resetting the RX Mode time and looping back to check for any more valid data packets if the automatic confirmation is not enabled; pulling the TR_SEL line to a first state to place the transceiver into transmit mode and making the TR_DATA line an output so that the transcoder can send data to the transceiver if the automatic confirmation is enabled; outputting the confirmation packet on the TR_DATA line, pulling the TR_SEL line to a second state to place the transceiver into receive mode, and making the TR_DATA line an input such that it can get data from the transceiver; resetting the RX Mode timer and looping back to look for more packets; disallowing a received address to activate the transcoder if no valid data packets are found or the received target address does not match the local address; checking, by the transcoder, to see if the RX Mode timer has expired; exiting the mode; and looping back and looking for more data packets if the timer has not expired.

### BRIEF DESCRIPTION OF THE DRAWINGS

FIG. 1 is a schematic view of a bi-directional wireless control system, in accordance with an embodiment;

FIG. 2 is a schematic view of a transcoder, in accordance with an embodiment;

FIG. 3 is a schematic view of a bi-directional wireless control system, in accordance with an embodiment;

FIG. 4 is a schematic view of a bi-directional transcoder system, in accordance with an embodiment;

FIG. 5 is a schematic view of a wireless control system with confirmation, in accordance with an embodiment;

FIG. 6 is a flow diagram of creating an address and assigning status line direction, in accordance with an embodiment;

FIG. 7 is a flow diagram of learning an address and setting Control Permissions, in accordance with an embodiment;

FIG. 8 is a flow diagram of a Serial Interface Engine (SIE), in accordance with an embodiment;

FIG. 9 is a flow diagram of a method of operation of a transcoder, in accordance with embodiments;

FIG. 10 is a flow diagram of a method for sending a transmission, in accordance with an embodiment; and

FIG. 11 is a flow diagram of a method for receiving a transmission, in accordance with an embodiment.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Encoder” as referred to herein relates to apparatus capable of converting the status of inputs, for example button or contact closures or other types of switch units, as binary data and combining the binary data with an identifier forming a data packet. The data packet is suitable to be communicated via a transmitted signal. The encoder comprises one or more encoder data lines operable to receive the electrical state of the inputs. The encoder further comprises one or more encoder output lines operable to communicate the data packet. The encoder may be of any suitable electronic device, including, but not limited to, physical circuitry and software manifestations of physical circuitry, and combinations thereof. As will be appreciated by those skilled in the art, the functions of the encoder can be implemented in dedicated logic, although a microcontroller or microprocessor based implementation is anticipated. In accordance with an embodiment of the present invention, the encoder is implemented in a microcontroller in the form of a Shrink Small Outline Package (SSOP), a packaging technology which is well known in the semiconductor packaging art. However, these are merely examples of encoders and claimed subject matter is not limited in these respects.

“Decoder” as referred to herein relates to apparatus operable for interpreting the data packet and interpret the binary data. The decoder comprises one or more decoder input lines operable to receive the data packet. The decoder further comprises one or more decoder output lines operable to communicate an electrical state. The binary data is interpreted by the decoder to set the decoder output lines to replicate the electrical states of the encoder data lines. The decoder may be of any suitable electronic device, including, but not limited to, physical circuitry and software manifestations of physical circuitry, and combinations thereof. As will be appreciated by those skilled in the art, the functions of the decoder can be implemented in dedicated logic, although a microcontroller or microprocessor based implementation is anticipated. In accordance with an embodiment of the present invention, the decoder described herein is implemented in a microcontroller in the form of a Shrink Small Outline Package (SSOP). However, these are merely examples of decoders and claimed subject matter is not limited in these respects.

In accordance with embodiments of the present invention, the encoder and decoder described herein are implemented as described in U.S. provisional patent application No. 60/955,627, filed on Aug. 13, 2007, which is in its entirety incorporated herewith by reference, PCT application PCT/US2007/080007, international filing date Sep. 28, 2007, which is in its entirety incorporated herewith by reference, U.S. provisional patent application No. 60/827,653, filed on Sep. 29, 2006, which is in its entirety incorporated herewith by reference, and U.S. provisional patent application No. 60/829,144, filed on Oct. 11, 2006, which is in its entirety incorporated herewith by reference.

“Transcoder” as referred to herein relates to apparatus operable to provide functionality of an encoder and a decoder.

“Application Circuitry” as referred to herein relates to apparatus operable to be controlled by the state of the decoder output lines. Examples of application circuitry include, but are not limited to, garage door motor systems, door locking systems, alarm systems, irrigation systems, dispensing systems, and environmental control systems. However, these are merely examples of application circuitry and claimed subject matter is not limited in these respects.

“Transceiver” as referred to herein relates to apparatus operable to send and receive data via a mode of transmission or communication. The mode of transmission or communication includes, but is not limited to, radio frequency (RF), infrared (IR), and electrical contact. These are merely examples of a mode of communication and claimed subject matter is not limited in these respects.

“Data packet” as referred herein relates to data that is combined and transmitted or communicated as a distinct set, such as, but not limited to, an identifier and a data block, and combinations thereof.

“Input line” as referred herein relates to an electrical conduit through which an electrical signal may be communicated into an apparatus.

“Output line” as referred herein relates to an electrical conduit through which an electrical signal may be communicated out of an apparatus.

“Status I/O line” and “Input/Output line” as referred herein relate to an electrical conduit through which an electrical signal may be communicated into and/or out of an apparatus.

“High” as referred herein is in reference to a voltage state of input and output lines. High refers to relative high voltage in a circuit including the input or output lines, such as, but not limited to, a supply voltage (Vcc). High is also referred to as a logic ‘1’.

“Low” as referred herein is in reference to a voltage state of input and output lines. Low refers to relative low voltage in a circuit including the input or output lines, such as, but not limited to, circuit ground (GND). Low is also referred to as a logic ‘0’.

In accordance with an implementation of a wireless control system, an encoder of a transmitter product records the electrical state of inputs as binary data and combines it with a unique identifier to form a command data packet that is encoded for security such that only a receiver product that is provided with a correct means is able to decode and validate the binary data contained in the command data packet. The command data packet is communicated to receiver product via a transmitted signal. Upon successful recovery and validation of the binary data, the decoder output lines of the receiver product are set to replicate the electrical states of the encoder input lines of the transmitter product. The decoder output lines are operable to be used to control application circuitry. The receiver product is operable to send a confirmation signal, either similarly encoded for security or not, to the receiver product as an indication that the command data packet from the transmitter product was correctly received.

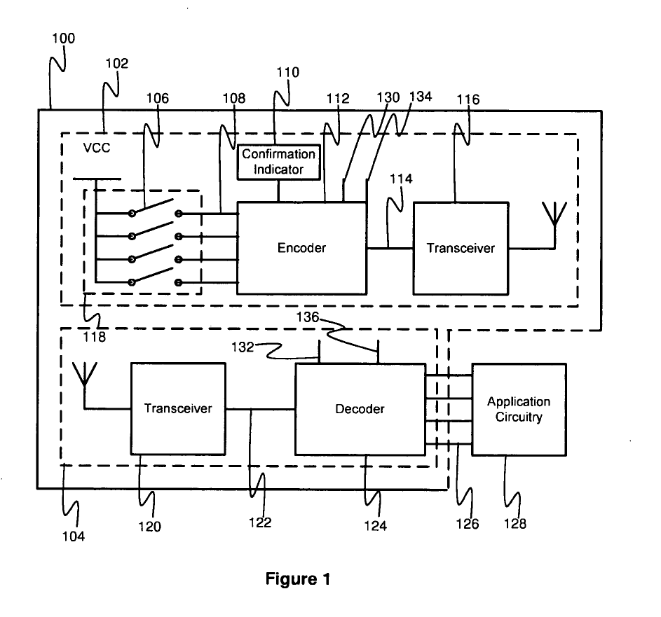

FIG. 1 is a schematic view of an embodiment of a bi-directional wireless control system 100, in accordance with an embodiment of the present invention. The bi-directional wireless control system 100 comprises a command product 102 and a control product 104, each operable for bi-directional wireless communication. The command product 102 is operable to send a command data packet to the control product 104. The command product 102 is also operable to receive a confirmation signal from the control product 104. The control product 104 is operable to receive the command data packet from the command product 102. The control product 104 is also operable to send a confirmation signal to the command product 102. The confirmation signal is used to indicate that the control product 104 has received the command data packet. The command product 102 further comprises an indicator 110 operable to provide an indication to a user that the command data packet was received by the control product 104. The control product 104 is operable to control application circuitry 128 based on the received command data packet.

Referring again to FIG. 1, the command product 102 comprises a switch unit 118, an encoder 112, and a first transceiver 116. The switch unit 118 comprises one or more switches 106, such as, but not limited to, electro-mechanical contacts operable for providing an open or closed electrical state to the encoder 112 communicated via an encoder input line 108. If the switch unit 118 communicates an electrical state to one or more encoder input lines 108 of the encoder 112, the encoder 112 is operable to generate a data packet representative of that electrical state. The encoder 112 communicates the command data packet to the first transceiver 116 via an encoder I/O line 114. The first transceiver 116 is operable to affect wireless transmission of the command data packet. The command data packet may be transmitted by any means of serial data transfer, such as, but not limited to, a radio frequency (RF) or infrared (IR) link.

The command product 102 further comprises a confirmation indicator 110 in communication with the encoder 112 which will be described below.

The control product 104 comprises a second transceiver 120 and a decoder 124. The control product 104 is operable for wireless communication with the command product 102, including the reception of the command data packet. The command data packet is communicated from the second transceiver 120 to the decoder 124 via a decoder input/output (I/O) line 122. The decoder 124 is operable to interpret the binary data representing the electrical state of the encoder input lines 108 from the command data packet. The decoder 124 comprises one or more output lines 126 that are operable for communication with application circuitry 128 that is to be controlled. The electrical state of the one or more decoder data output lines 126 is determined by the content of the binary data of the command data packet representing the electrical state of the encoder input lines 108.

The decoder 124 is further operable to create a confirmation signal and communicate the confirmation signal to the second transceiver 120 via the decoder I/O line 122. The second transceiver 120 is operable to transmit the confirmation signal to the first transceiver 116. The first transceiver 116 is operable to communicate the confirmation signal to the encoder 112. If the received confirmation signal is valid, the encoder 112 activates the confirmation indicator 110. The confirmation indicator 110 is operable to alert a user to the reception of the confirmation signal from the control product 104.

The confirmation indicator 110 may comprise any apparatus suitable for alerting a user. Examples of a confirmation indicator 110 include, but are not limited to, a light source, an alpha and/or numeric display, an audio source, a vibratory source, among many others, operable for producing a visible and/or audible and/or tactile response. The reception of the confirmation signal by the command product 102 provides the user with a measure of confidence that the control product 104 has received the command data packet.

In accordance with embodiments, the encoder 112 and/or decoder 124 further comprise one or more program input lines 130, 132 operable for, but not limited to, accepting signals to program the encoder 112 and/or decoder 124, such as, but not limited to, setting the encoder 112 and/or decoder 124 for specific functions. In accordance with embodiments, the encoder 112 and/or decoder 124 further comprises one or more interface input/output (I/O) lines 134, 136 operable for interfacing with a Serial Interface Engine (SIE) within the encoder 112 and/or decoder 124. The SIE is operable to facilitate communications with external devices, such as, but not limited to, an external computer, controller, or other similar device, for the purpose of, but not limited to, programming the encoder 112 and/or decoder 124.

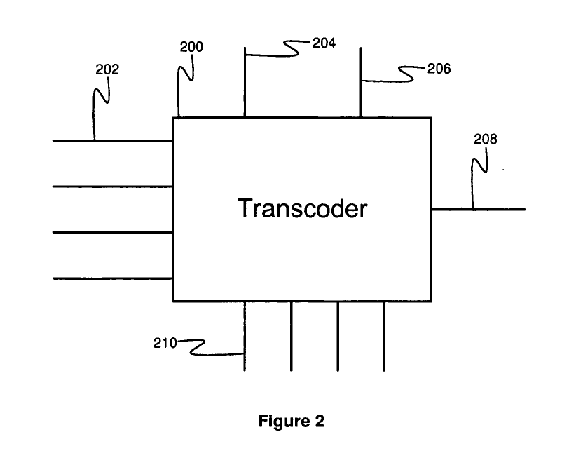

FIG. 2 is a schematic representation of a transcoder 200, in accordance with an embodiment. The transcoder 200 comprises means operable to provide functionality of an encoder and a decoder. The transcoder 200 may be of any suitable electronic device, including, but not limited to, physical circuitry and software manifestations of physical circuitry, and combinations thereof. As will be appreciated by those skilled in the art, the functions of the transcoder 200 can be implemented in dedicated logic, although a microcontroller or microprocessor based implementation is anticipated. In accordance with an embodiment of the present invention, the transcoder 200 comprising functionality of an encoder and decoder described herein is implemented in a microcontroller in the form of a Shrink Small Outline Package (SSOP). However, these are merely examples of transcoders 200 and claimed subject matter is not limited in these respects.

The transcoder 200 comprises one or more status lines 202, 210, a program line 204, and a data transmission line 208. The status lines 202, 210 may be dynamically programmed to function as input lines and/or output lines as will be discussed below. In other embodiments one or more status lines 202, 210 are statically configured as input lines and one or more status lines 202, 210 are statically configured as output lines. For convenience, status line inputs 202 refers to status lines that are either statically configured or dynamically programmed as input lines, and status line outputs 210 refers to status lines that are either statically configured or dynamically programmed as output lines.

The transcoder 200 further comprises input/output (I/O) lines for particular purposes. In accordance with an implementation, the transcoder 200 further comprises a data transmission I/O line 208 and a program input line 204. The data transmission I/O line 208 is operable for sending and receiving data from a means for data transmission, such as a transmitter, receiver, or transceiver. The program input line 204 is operable for, but not limited to, accepting signals to program the transcoder 200, such as, but not limited to, setting the transcoder 200 for specific functions, and/or setting the status lines 202, 210 as either status line inputs 202 or status line outputs 210, for example. In accordance with embodiments, the transcoder 200 comprises one or more interface input/output (I/O) lines 206 operable for interfacing with a Serial Interface Engine (SIE) within the transcoder 200. The SIE is operable to facilitate communications with external devices, such as, but not limited to, an external computer, controller, or other similar device, for the purpose of, but not limited to, programming the transcoder 200.

In accordance with an implementation, a transcoder 200 is operable to record the electrical state of status lines that are programmed to be status line inputs 202 as binary data. The transcoder 200 is operable to combine the binary data with a unique identifier to form a command data packet. The command data packet may be encoded or encrypted for security such that only another transcoder that is provided with a correct means is able to decode/decrypt and validate the binary data contained in the command data packet. The command data packet may be communicated to another transcoder 200 via a transmitted signal communicated through the data transmission line 208. Upon successful recovery and validation of the binary data from the command data packet, status lines that are programmed to be status line outputs 210 on another transcoder 200 are set to replicate the electrical state of the status line inputs 202 on the first transcoder 200. The status line outputs 210 on the other transcoder 200 are operable to be used to control application circuitry in communication therewith.

The transcoder 200 is also operable to receive a command data packet from another transcoder 200 where the command data packet is representative of the electrical state of status lines that are programmed to be status line inputs 202 as binary data on the other transcoder 200. The command data packet may be communicated to the transcoder 200 via a transmitted signal communicated through the data transmission line 208. Upon successful recovery and validation of the binary data from the command data packet, status lines that are programmed to be status line outputs 210 are set to replicate the electrical state of the status line inputs on the other transcoder 200. The status line outputs 210 on the transcoder 200 are operable to be used to control application circuitry in communication therewith.

The transcoder 200 is also operable to receive a confirmation data packet from a second transcoder 200 where the confirmation data packet is an acknowledgement that the second transcoder correctly received a command data packet from the transcoder. The confirmation data packet may be communicated to the transcoder 200 via a transmitted signal communicated through the data transmission line 208. Upon successful recovery and validation of the binary data from the confirmation data packet, an output line Error! Reference source not found. is activated to indicate that a confirmation data packet was received.

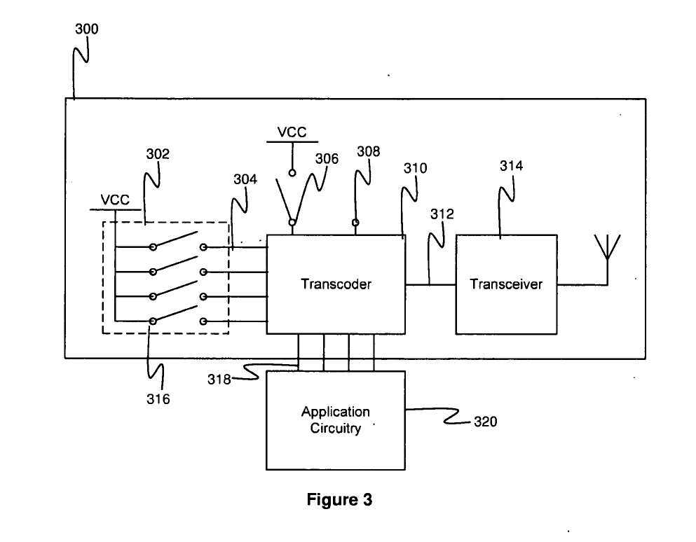

FIG. 3 is a schematic view of an embodiment of a transcoder product 300. The transcoder product 300 comprises a switch unit 302, a transcoder 310, and a transceiver 314. The transcoder 310 comprises a plurality of status line inputs 304 and status line outputs 318 operable to affect communication as described above. The switch unit 302 comprises one or more switches 316 in electrical communication with the status line inputs 304. An example of switches 316 includes, such as, but not limited to, electro-mechanical contacts operable for providing an open or closed electrical state to the transcoder 310 communicated via the status line inputs 304. If the switch unit communicates an electrical state to one or more status line inputs 304, the transcoder 310 is operable to generate a command data packet representative of that electrical state. The command data packet is communicated from the transcoder 310 to the transceiver 314 via a data transmission I/O line 312. The transceiver 314 is operable to affect the wireless transmission of the command data packet. The command data packet can be transmitted by any means of serial data transfer, such as, but not limited to, a radio frequency (RF) or infrared (IR) link.

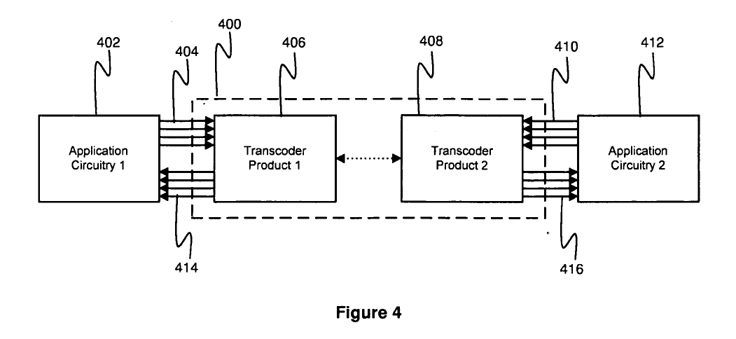

The transceiver 314 is suitable for wireless communication with another transceiver, including the communication of the command data packet therebetween. FIG. 4 is a schematic representation of an embodiment of a bi-directional wireless control system 400 comprising a first transcoder product 406 and a second transcoder product 408. The first transcoder product 406 and second transcoder product 406 are shown in electrical communication with first application circuitry 402 and second application circuitry 412, respectively.

Each of the first transcoder product 406 and a second transcoder product 408 are substantially as described for the embodiment of FIG. 3.

In accordance with an implementation of a bi-directional wireless control system 400, a first transcoder product 406 records the electrical state of first status I/O lines that are programmed to be status line inputs 404 as binary data and combines it with a unique identifier to form a command data packet that is encoded for security such that only the second transcoder product 408 that is provided with a correct means is able to decode and validate the binary data contained in the command data packet. The command data packet is communicated to the second transcoder product 408 via a transmitted signal. Upon successful recovery and validation of the binary data from the command data packet, second status I/O lines that are programmed to be status line outputs 416 on the second transcoder product 408 are set to replicate the electrical state of the status line inputs 404 on the first transcoder product 406. The second status line outputs 416 on the second transcoder product 408 are operable to be used to control second application circuitry 412.

The second transcoder product 408 is operable to record the electrical state of second I/O lines that are programmed to be status line inputs 410 and to send a command data packet to the first transcoder product 406. The first transcoder product 406 is also operable to have first status I/O lines that are programmed to be status line outputs 414 that control first application circuitry 402.

The command data packet is communicated from the transceiver 314 to the transcoder 310 via a data transmission I/O line 312. The transcoder 310 is operable to interpret the command data packet comprising the binary data representing the electrical state of the second transcoder status line inputs 410. The transcoder 310 has one or more status line outputs 414 that are suitable for communication with the application circuitry 402 that is to be controlled. The electrical state of the one or more transcoder status line outputs 414 is determined by the content of the binary data of the command data packet representing the electrical state of the second transcoder status line inputs 410.

In accordance with an implementation of a bi-directional wireless control system, a first transcoder records the electrical state of inputs as binary data and combines it with a unique identifier to form a command data packet that is encoded for security such that only a second transcoder that is provided with a correct means is able to decode and validate the binary data contained in the command data packet. The command data packet is communicated to the second transcoder via a transmitted signal. Upon successful recovery and validation of the binary data from the command data packet, second transcoder output lines are set to replicate the electrical state of the first transcoder data lines. The second transcoder output lines are operable to be used to control application circuitry. The second transcoder is operable to send a confirmation data packet, similarly encoded for security, to the first transcoder as an indication that the command data packet from the first transcoder was correctly received.

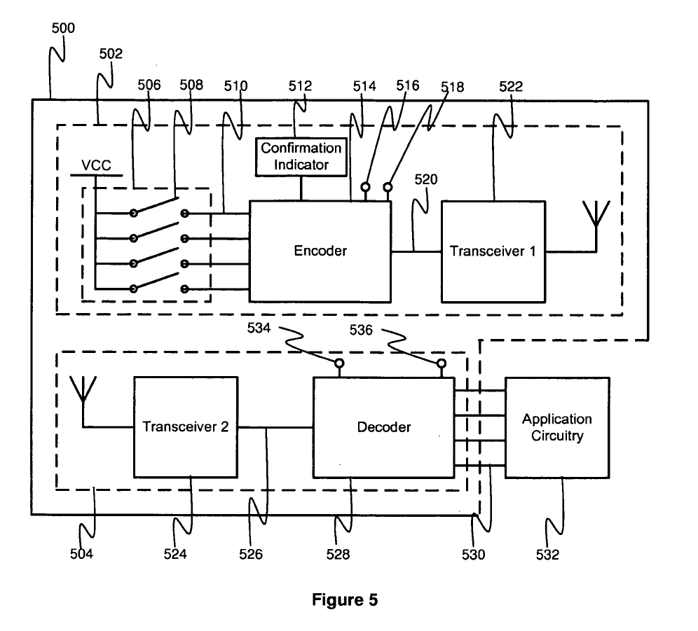

FIG. 5 is a schematic view of an embodiment of a wireless control system with confirmation 500, in accordance with an embodiment. The wireless control system with confirmation 500 comprises a transmitter product 502 and a receiver product 504, each operable for bi-directional wireless communication. The transmitter product 502 is operable to transmit a command data packet to the receiver product 504. The transmitter product 502 is also operable to receive a confirmation data packet from the receiver product 504. The receiver product 504 is operable to receive the command data packet from the transmitter product 502. The receiver product 504 is also operable to send a confirmation data packet to the transmitter product 502. The confirmation data packet is used to indicate that the receiver product has received and correctly decoded the command data packet. The transmitter product 502 further comprises an indicator 512 operable to provide an indication to a user that the command data packet was received and correctly decoded by the receiver product 504. The receiver product 504 is operable to control application circuitry 532 based on the received command data packet.

Referring again to FIG. 5, the transmitter product 502 comprises a switch unit 506, an encoder 514, and a first transceiver 522. The switch unit 506 comprises one or more switches 508 operable for providing an open or closed electrical state to the encoder 514 communicated via one or more encoder status input lines 510. If the switch unit 506 communicates an electrical state to one or more encoder status input lines 510, the encoder 514 is operable to generate a command data packet representative of that electrical state. The encoder 514 communicates the command data packet to the first transceiver 522 via an encoder data I/O line 520. The first transceiver 522 is operable to affect the wireless transmission of the command data packet. The command data packet may be transmitted by any means of serial data transfer, such as, but not limited to, a radio frequency (RF) or infrared (IR) link.

The transmitter product 502 further comprises a confirmation indicator 512 in communication with the encoder 514 which will be described below.

The receiver product 504 comprises a second transceiver 524 and a decoder 528. The receiver product 504 is operable for wireless communication with the transmitter product 502, including the reception of the command data packet. The command data packet is communicated from the second transceiver 524 to the decoder 528 via a decoder data I/O line 526. The decoder 528 is operable to interpret the command data packet comprising the binary data representing the electrical state of the encoder status input lines 510. The decoder 528 has one or more decoder status output lines 530 that are operable for communication with application circuitry 532 that is to be controlled. The electrical state of the one or more decoder status output lines 530 is determined by the content of the binary data of the command data packet representing the electrical state of the encoder status input lines 510.

The receiver product 504 is further operable to communicate a confirmation data packet to the transmitter product 502 to indicate that the electrical state of the decoder status output lines 530 are set in accordance with the command data packet. The decoder 528 is operable to generate a confirmation data packet comprising the binary data representative of the electrical state of the decoder status output lines 530. A confirmation data packet is communicated to the second transceiver 524 via a decoder data I/O line 526. The second transceiver 524 is operable to transmit the confirmation data packet to the first transceiver 522. The first transceiver 522 is operable to communicate the confirmation data packet to the encoder 514 via an encoder data I/O line 520. The encoder 514 is operable to decode the binary data representing the electrical states of the decoder status output lines 530 from the confirmation data packet, compare the confirmation data packet with that of the command data packet, and if there is a match, communicate a confirmation signal to the confirmation indicator 512. The confirmation indicator 512 is operable to alert a user to the continuity between what was intended to be transmitted by the transmitter product 502 and what was actually interpreted by the receiver product 504.

In yet another embodiment, the receiver product 504 is further operable to communicate a confirmation data packet to the transmitter product 502 to indicate that the electrical state of the decoder status output lines 530 are set in accordance with the command data packet. The decoder 528 is operable to query the electrical state of the decoder status output lines 530 and generate binary data representative of the electrical state of the decoder status output lines 530. The decoder 528 is operable to generate a confirmation data packet comprising the binary data representative of the electrical state of the decoder status output lines 530. A confirmation data packet is communicated to the second transceiver 524 via a decoder data I/O line 526. The second transceiver 524 is operable to transmit the confirmation data packet to the first transceiver 522. The first transceiver 522 is operable to communicate the confirmation data packet to the encoder 514 via an encoder data I/O line 520. The encoder 514 is operable to decode the binary data representing the electrical states of the decoder status output lines 530 from the confirmation data packet, compare the confirmation data packet with that of the command data packet, and if there is a match, communicate a confirmation signal to the confirmation indicator 512. The confirmation indicator 512 is operable to alert a user to the continuity between what was intended to be transmitted by the transmitter product 502 and what was actually interpreted by the receiver product 504.

In yet another embodiment, the receiver product 504 is further operable to communicate a confirmation data packet to the transmitter product 502 to indicate that the command binary data was properly received. After the decoder 528 extracts the binary data from the command data packet, the decoder 528 is operable to generate a confirmation data packet comprising the binary data. A confirmation data packet is communicated to the second transceiver 524 via a decoder data I/O line 526. The second transceiver 524 is operable to transmit the confirmation data packet to the first transceiver 522. The first transceiver 522 is operable to communicate the confirmation data packet to the encoder 514 via an encoder data I/O line 520. The encoder 514 is operable to decode the binary data from the confirmation data packet, compare the binary data from the confirmation data packet with that of the binary data from the command data packet, and if there is a match, communicate a confirmation signal to the confirmation indicator 512. The confirmation indicator 512 is operable to alert a user to the continuity between what was intended to be transmitted by the transmitter product 502 and what was actually interpreted by the receiver product 504.

In accordance with embodiments, the confirmation indicator 512 alerts the user that the electrical state of the individual decoder status output lines 530 or the binary data as provide by the confirmation data packet matches that of the command data packet. For example, but not limited thereto, where there are four decoder status output lines 530, the confirmation indicator 512 provides a single visual cue, such as an illumination of a green LED that there is a match between the respective binary data of the confirmation data packet and the command data packet, and illumination of a red LED if there is no match.

In accordance with another embodiment, the confirmation indicator 512 alerts the user to the electrical state of the individual decoder status output lines 530. For example, but not limited thereto, where there are six decoder status output lines 530, the confirmation indicator 512 provides indication of the electrical state of each of the six decoder status output lines 530.

The confirmation indicator 512 may comprise any apparatus suitable for alerting a user. Examples of a confirmation indicator 512 include, but are not limited to, a light source, an alpha and/or numeric display, an audio source, a vibratory source, among many others, operable for producing a visible and/or audible and/or tactile response. The reception of the confirmation data packet by the transmitter product 502 provides the user with a measure of confidence that the receiver product 504 has received the command data packet and/or that the receiver product correctly interpreted the command data packet.

In accordance with embodiments, the encoder and decoder 514, 528 further comprise one or more program input lines 516, 534 operable for, but not limited to, accepting signals to program the encoder or decoder 514, 528, such as, but not limited to, setting the encoder or decoder 514, 528 for specific functions. In accordance with embodiments, the encoder and decoder 514, 528 further comprise one or more interface input/output (I/O) lines 518, 536 operable for interfacing with a Serial Interface Engine (SIE) within the encoder and decoder 514, 528. The SIE is operable to facilitate communications with external devices, such as, but not limited to, an external computer, controller, or other similar device, for the purpose of, but not limited to, programming the encoder and decoder 514, 528.

### Unique Address Creation

In accordance with an embodiment, each transcoder comprises a unique identifier. The unique identifier provides an identification means by which associations between multiple transcoders may be created. In accordance with an implementation, each transcoder is assigned a unique number referred to as an address. In accordance with an embodiment of the present invention, an address is provided by randomizing a number for as long as an input line is activated.

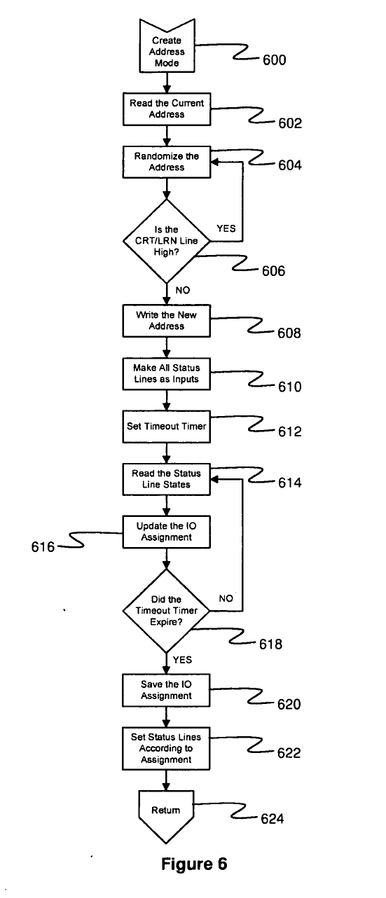

FIG. 6 is a flow diagram of an embodiment of a method 600 for creating an address. Once this mode is entered, the transcoder reads the current address 602 and runs a randomizing algorithm 604. The randomizing algorithm is run until a input line, referred to as the CRT/LRN line, is caused to go low 606. Once the CRT/LRN line goes low, the transcoder writes the resulting address to memory 608.

### Dynamic Status Line Direction

In accordance with an embodiment, the transcoder comprises a number of status I/O lines 304, 318 that are operable to interface with external devices, as shown in FIG. 3.

By way of example, but not limited thereto, where the status I/O line is configured to be a status line input, then it may be coupled to a switch unit 302 or similar device. Where the status I/O line is a status line output, it may be coupled to application circuitry 320. The communication direction of the status I/O lines (input or output) may be dynamically determined by the user during set-up or programmed into the transcoder through the SIE.

Referring again to FIG. 6, in accordance with an embodiment of a method, the transcoder is caused to make all of the status I/O lines as status line inputs 610 and starts a Timeout timer 612. The logic states of the status line inputs are read by the transcoder 614. If a status line input is high, then the transcoder updates the assignment of the status I/O line to make that status I/O line a status line input 616. The transcoder continues to monitor the status I/O lines until the timeout timer expires 618, at which point the transcoder writes the assignments to memory 620. Any status I/O lines that were activated are assigned as status line inputs and the remaining status I/O lines are assigned as status line outputs. The status I/O lines are set according to the assignment 622 and the mode is exited 624.

### Associating Transcoders

In accordance with an embodiment, an association between a transmitting transcoder and a receiving transcoder is made before the receiving transcoder will accept commands from the transmitting transcoder and cause an action. In accordance with an embodiment of the present invention, an association between a transmitting transcoder and a receiving transcoder is made by activating an input line on the receiving transcoder to place it into a special Learn Mode. A command data packet comprising an address associated with the sending transcoder is sent from the transmitting transcoder and received by the receiving transcoder. The receiving transcoder is operable to store the received address in memory.

The second method of creating an association between two transcoders is to program the address and Control Permissions through the SIE.

### Control Permissions

In accordance with an embodiment, the transcoder is operable such that the user or manufacturer may set “button level” Control Permissions. Control Permission settings determine how the receiving transcoder responds to the reception of a valid command, either allowing the activation of a particular status line output or not. The receiving transcoder may be programmed with the permission settings during set-up, and those permissions are retained in the receiving transcoder's non-volatile memory.

In accordance with an embodiment, once the receiving transcoder has been placed into Learn Mode, the status line inputs that are to be authorized for use are activated on the transmitting transcoder. The receiving transcoder saves the activated status line outputs as the Control Permissions. If a particular status line output is not activated in this set-up phase, then the receiving transcoder will not allow that specific transmitting transcoder to activate that particular status line output.

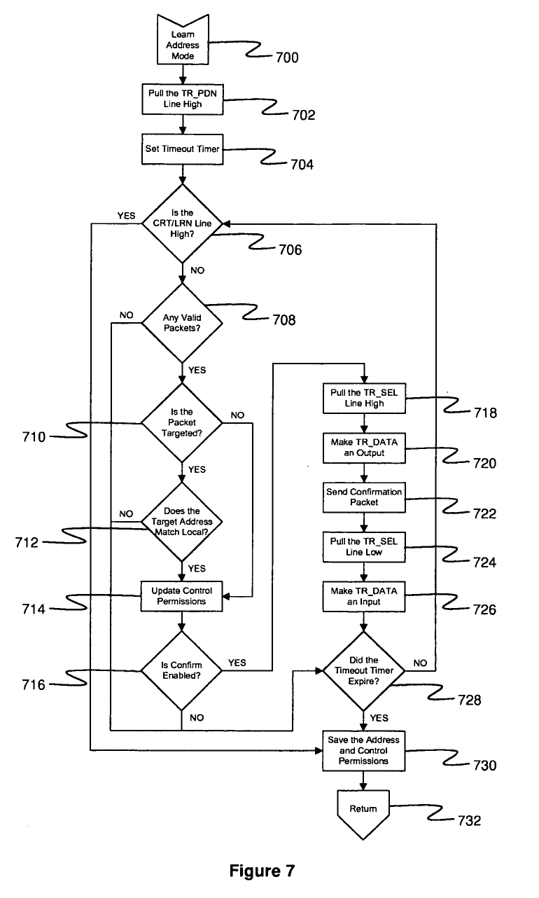

FIG. 7 is a flow diagram of an embodiment of a method for a transcoder to learn an address and set Control Permissions 700. Once in this mode, the transcoder pulls one of its transceiver control lines, referred to as the TR_PDN line, high 702 to activate an external transceiver. The transcoder starts a timer 704 and checks the logic state of one of its input lines 706, referred to as the CRT/LRN line. If the CRT/LRN line is high 706, then the transcoder saves the received address in memory 730. If the CRT/LRN line is low 706, the transcoder checks for valid packets 708. If there are no valid packets 708, the transcoder checks to see if the Timeout timer has expired 728. If there are valid packets 708, the transcoder checks to see if the packet is targeted, meaning that it is intended for a specific transcoder 710. If the packet is targeted, then the transcoder checks to see if the target address matches its local address 712. If the target address does not match 712, the transcoder checks to see if the Timeout timer has expired 728. If the target address matches 712 or if the packet is not targeted 710, then the address is saved and the Control Permissions are updated 714. The transcoder checks to see if the automatic confirmation is enabled 716 and, if so, pulls a transceiver control line referred to as the TR_SEL line high to place an external transceiver 314 into transmit mode 718. The transcoder makes the TR_DATA line 312 an output 720 so that it can send data packets to the transceiver 314. The transcoder outputs the confirmation packet on the TR_DATA line 722, pulls the TR_SEL line low 724 to place the transceiver 314 into receive mode, and makes the TR_DATA line 312 an input 726 so that it can receive data from the transceiver 314. It checks to see if the Timeout timer has expired 728. If not, then the transcoder loops back to check if the CRT/LRN line is high 706. If the timeout has expired 728, then the transcoder saves the received address in memory 730. The transcoder saves all activated status lines as the Control Permissions 730, and exits Learn Address Mode 732.

### Serial Interface Engine (SIE)

In accordance with an embodiment, a Serial Interface Engine (SIE) allows serial communication between a transcoder and an external device. The SIE interface uses a simple command set and protocol to allow the external device to control features within the transcoder. Examples of features that may be controlled with the SIE include, but are not limited to:

Read the current address and status line configurations

Write a new address and status line configurations

Read the address and Control Permissions for a specific learned device

Write the address and Control Permissions for a specific learned device

Read the address of the current targeted device

Write the address of the desired target device

Read the custom data value that will be sent along with the command

Write in a custom data value that is to be sent with the command

Read the current latch mask, which is used to set the outputs to either latched or momentary

Write a new latch mask

Read the current state of the transcoder's status lines

Write the value of the status line inputs to be sent and the number of packets to send.

Enable or disable automatic confirmation

Enable or disable Targeted Device Addressing

Enable or disable custom data transmission

Return to default state

In accordance with an embodiment, the interface is implemented as a single I/O line for data with an additional output for data flow control. The protocol is a simple serial construction, with the message contents sent into the transcoder and the transcoder's response dependant upon the specific command being used.

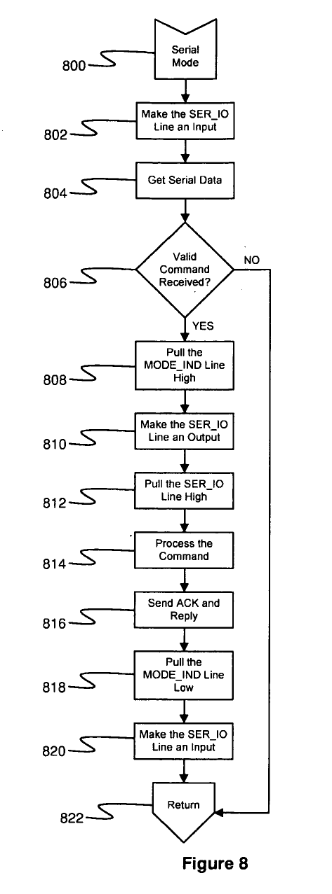

FIG. 8 is a flow diagram of a method for a Serial Interface Engine 800, in accordance with an embodiment. Once in this mode, a transcoder makes an input line, referred to as the SER_IO line, an input 802 so that the transcoder may get a serial command 804. If a valid command is not received 806 by the transcoder, then the transcoder exits the mode 822. If a valid command is received 806, the transcoder pulls an output line, referred to as the MODE_IND line, high 808 to indicate that the SER_IO line is an output and will send data. The transcoder then makes the SER_IO line an output 810 and pulls the line high 812. The transcoder processes the command, either reading data from memory or writing data to memory 814. The transcoder sends an acknowledgement and a reply, if required by the command 816. The transcoder pulls the MODE_IND line low 818, makes the SER_IO line an input 820, and exits the mode 822.

### Transceiver Control

In accordance with an embodiment, a transcoder controls power to a transceiver by way of an output line, referred to as the TR_PDN line. The transcoder is operable to power down the transceiver until needed, greatly reducing current consumption and extending battery life. The transcoder also controls the mode of the transceiver through an output line, referred to as the TR_SEL line. The transcoder is operable to place the transceiver into either transmit or receive mode.

In accordance with an embodiment of a method, prior to sending a command, a transcoder activates the TR_PDN line to turn on a transceiver. The transcoder then activates the TR_SEL line to turn the transceiver into the functionality of a transmitter. If the procedure is complete, the transcoder deactivates the TR_PDN line and the TR_SEL line.

A transcoder does not know when a transmission will occur, so the transcoder cannot wake a transceiver only during a transmission. In accordance with an embodiment, the transcoder supplies power to the transceiver and turns the transceiver into the functionality of a receiver, looks for valid data for a predetermined period of time, and powers down for a predetermined period of time.

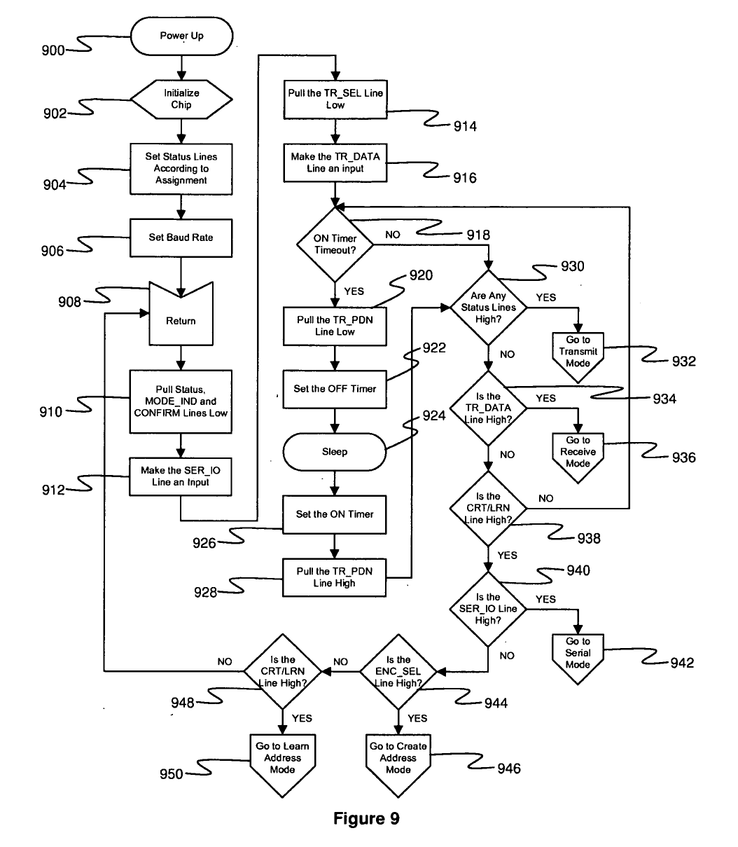

FIG. 9 is a flow diagram of an embodiment of a method of operation of a transcoder 900. Upon power up, the transcoder goes through a series of initialization steps 902-912. The transceiver control begins when the transcoder pulls the TR_SEL line low 914 to place the transceiver into receive mode. It makes the TR_DATA line an input 916 so that it can get data from the transceiver. An ON Timer is checked 918 to see if the timer has expired. If the ON timer has not expired 918, then the transcoder input lines are checked 930, 934, 938, 940, 944, 948 to see if the transcoder should go into a specific mode of operation 932, 936, 942, 946, 950. If the ON timer has expired 918, then the transcoder pulls the TR_PDN line low 920 to deactivate the transceiver. The transcoder then sets an OFF Timer 922 and goes to sleep 924. When the OFF timer expires, the transcoder wakes up and sets the ON timer 926. The transcoder pulls the TR_PDN line high 928 to reactivate the transceiver 314. The transcoder checks the transcoder input lines 930, 934, 938, 940, 944, 948 to see if the transcoder should go into a specific mode of operation 932, 936, 942, 946, 950 until the ON timer expires 918.

### Transmission Confirmation

Traditionally, a remote control link has operated in only one direction, from a transmitter product to a receiver product. This required that the receiver product to provide the user with some sort of feedback indicating that the transmission was received. For example, a car's horn sounds when the command is received to lock the doors. In accordance with embodiments, a bi-directional system is provided that is operable such that a confirmation transmission can be sent from the receiver product to the transmitter product so that the feedback can be provided closer to the user. For example, but not limited thereto, embodiments of the bi-directional transcoder system is operable such that when a car receives a command from a transcoder to lock the doors, the transcoder controlling the door lock transmits a confirmation to the related transcoder product in the form of a keyfob. This would allow the car's keyfob to alert a user, such as, but not limited to, vibrate or light up, indicating to the user that the doors are locked.

In accordance with an embodiment, the confirmation transmission is automatically sent, without need for external circuitry or user interaction. The confirmation may be deactivated through the SIE if it is desired to reduce the number of transmissions in order to reduce the chance for interference among multiple devices, for example.

### Targeted Device Addressing

In accordance with embodiments, each transcoder has a unique address, enabling the possibility to choose which target device is to respond to a particular command. The address of the target device is included in the transmission so that only the target device with that address will respond, even though there may be a great many devices that received the transmission.

### Custom Data Transmission

In accordance with an embodiment, the transcoder is able to send custom data with the transmission of the command data packet. This custom data may be defined by the user or the system in which the transcoder is used. The custom data is output by the receiving transcoder through a transcoder output line.

### Transcoder Identification Output

In accordance with embodiments, the transcoder uses an identifier, such as, but not limited to, a serial number, address, or ID, to determine if a transcoder is associated or learned therewith. The receiving transcoder outputs an identifier for a transmitting transcoder that sent a signal. This enables the receiving transcoder to identify the originating transcoder and take a predetermined action.

In accordance with embodiments, a receiving transcoder identifies and outputs a transcoder-assigned identification number for a specific transmitting transcoder. A transmitting transcoder's Address and Control Permissions (which, as a group, are referred to as User Data) are stored in a memory location within the receiving transcoder. The receiving transcoder outputs a binary number that corresponds to the memory location where the transmitting transcoder's information is stored. The User Data of the first transmitting transcoder that is learned by the receiving transcoder is stored in location number 1, so that the first transmitting transcoder ID number will be a binary 1. The User Data of the second transcoder is saved in location 2, so that the second transmitting transcoder ID number will be a binary 2, and so forth. Once the receiving transcoder receives a valid signal from a transmitting transcoder, it outputs the memory location number in which the transmitting transcoder's User Data was stored. The ID number is output with each valid data packet received along with the current status line states and a custom data byte, if enabled. A personal computer, microcontroller, or other computer, among others, may associate this ID with a particular transceiver product.

### Open Reception Mode

The number of individual devices that can be in a system is limited by the number of unique addresses available to the devices. This number is further reduced by implementing the transcoder in a manner in which processing speed and memory are limited. This implementation is necessary to meet the cost, power consumption, and size requirements for use in some products. However, some applications may have faster processors and more memory available, such as, but not limited to, a personal computer. In accordance with an embodiment, the transcoder may be operated in an Open Reception Mode in which all valid transmissions are accepted. The received address and commands are output on a transcoder output line as serial data. This enables the user to have an external device that can store the learned users and control permissions, thereby expanding the possible size of the system from what is possible with the transcoder alone. Checks are performed on the packet structure and data content, such as, but not limited to through a CRC checksum process, but no validation is performed on the address.

### Latched or Momentary Outputs

In accordance with an embodiment, the transcoder can have either momentary or latched status line outputs. With momentary status line outputs, the transcoder activates the status line outputs only for as long as valid data packets are received instructing the transcoder to activate them. Once the data packets stop and the transcoder times out, the status line outputs are deactivated. With latched outputs, the transcoder activates the status line outputs upon reception of a valid data packet and keeps them activated until the data packet is received again, at which point the transcoder deactivates them. The transcoder must see a break in the data packet transmission and time out before it will toggle the state of the status line outputs.

In accordance with an embodiment, the latched or momentary states can be controlled wherein all of the status line outputs are controlled as a group through the state of a transcoder input, referred to as the LATCH line. If the LATCH line is in one state, then all of the status line outputs are latched. If the LATCH line is in the other state, then all of the status line outputs are momentary.

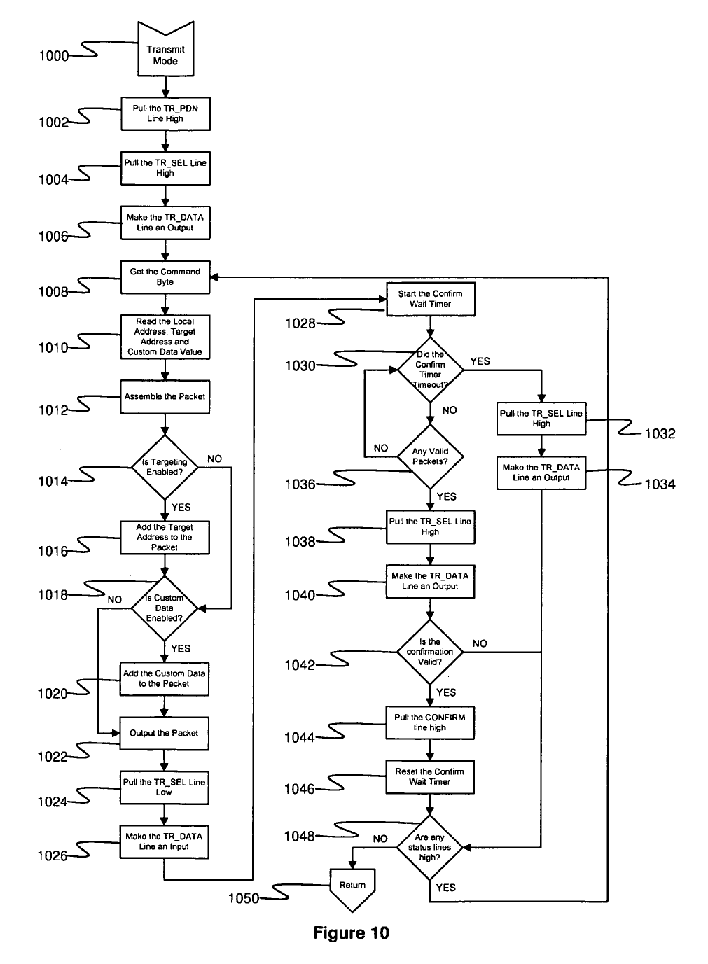

In accordance with another embodiment, the latched or momentary state of the status line outputs can be set individually with the use of a programmed mask. The mask is programmed into the transcoder through the SIE and is saved in memory. When a command is received, the transcoder compares the received command to this mask. If a command is received to activate a specific status line output and that line is set to latched, then the transcoder toggles its state. If a specific status line outputs is set to momentary, then the transcoder activates or deactivates the line according to the received command. FIG. 10 is a flow diagram of an embodiment of a method for sending a transmission 1000. The transcoder pulls the TR_PDN line high 1002 to turn on the transceiver, pulls the TR_SEL line high 1004 to place the transceiver into transmit mode, and makes the TR_DATA line an output 1006 so that it can send data to the transceiver. The transcoder checks the logic state of the Status Line inputs and creates the Command Byte 1008. The transcoder reads the local address, target address, and custom data value from memory 1010. The data packet is assembled 1012, consisting of a preamble, a local Address, and a Command Byte. If targeting is enabled 1014, then the transcoder adds the target address to the data packet 1016, otherwise it will check to see if custom data is enabled 1018. If custom data is enabled 1018, the transcoder adds the custom data value to the data packet 1020, otherwise the transcoder outputs the data packet 1022 on the TR_DATA line 312. The transcoder pulls the TR_SEL line low 1024 to place the transceiver into receive mode, makes the TR_DATA line an input 1026, and starts a timer 1028. The transcoder waits in a loop until either the timer times out 1030 or a valid confirmation data packet is received 1036. When the timer times out 1030, the transcoder pulls the TR_SEL line high 1032 to place the transceiver into transmit mode and makes the TR_DATA line an output 1034 so that it can send data to the transceiver. It then checks to see if any status line inputs are high 1048. If any status line inputs are high 1048, then the transcoder gets the command byte 1008 and starts the loop again. If no status line inputs are high 1048, then the transcoder exits the mode 1050. If a valid confirmation packet is received 1036, then the transcoder pulls the TR_SEL line high 1038 to place the transceiver into transmit mode and makes the TR_DATA line an output 1040 so that it can send data to the transceiver. If the confirmation is valid 1042, then the transcoder pulls the CONFIRM line high 1044, resets the timer 1046, and checks to see if any status line inputs are high 1048. If any status line inputs are high 1048, then the transcoder gets the command byte 1008 and starts the loop again. If no status line inputs are high 1048, then the transcoder exits the mode 1050.

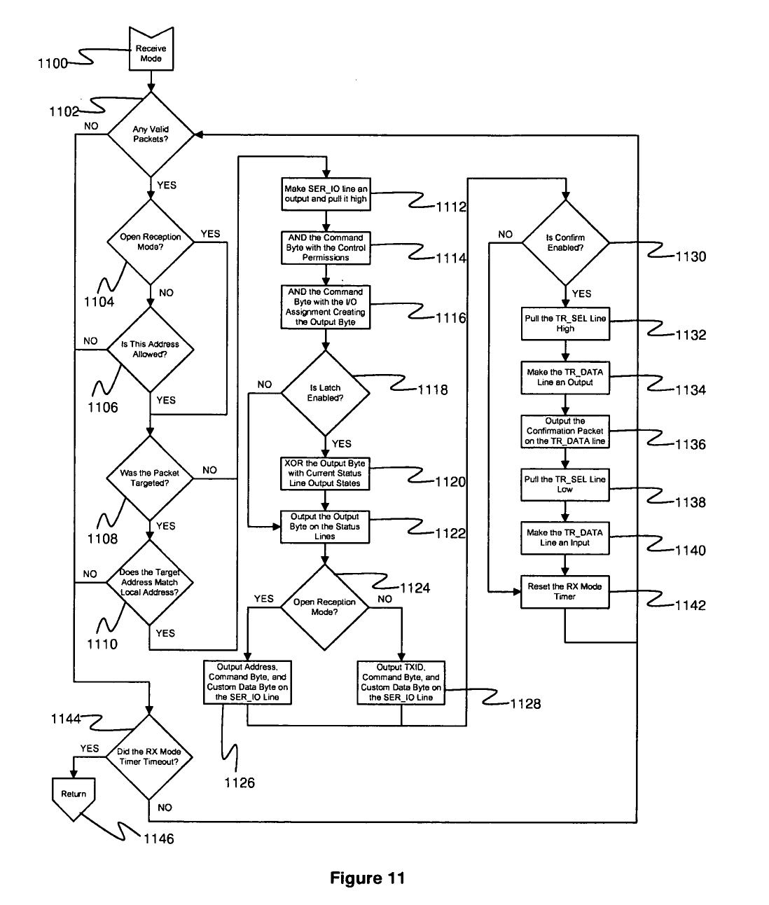

FIG. 11 is a flow diagram of an embodiment of a method for receiving a transmission 1100. Once in this mode, the transcoder looks for any valid data packets 1102. If no valid data packets are received 1102, then the transcoder checks to see if the RX Mode timer has timed out 1144. If the transcoder receives valid data packets 1102, then the transcoder checks to see if the transcoder is in Open Reception mode 1104. If the transcoder is in Open Reception mode, then the transcoder skips checking to see if the address is authorized. If the transcoder is not in Open Reception mode 1104, the transcoder will check to see if the received address is in the transcoder's memory and is authorized to activate the transcoder 1106. If the address is not authorized, then the transcoder checks to see if the RX Mode timer has timed out 1144. The transcoder then checks to see if the received data packet is a targeted packet 1108, meaning that the data packet is intended for a specific transcoder. If the data packet is targeted 1108, then the transcoder checks to see if the transcoder's local address matches the target address in the received data packet 1110. If the received target address does not match the local address 1110, then the transcoder checks to see if the RX Mode timer has timed out 1144. If the received data packet is not targeted 1108, or if the local address matches the target address 1110, then the transcoder makes the SER_IO line an output and pulls it high 1112. The transcoder performs a logical AND operation with the Command Byte and the Control Permissions 1114 to get the Control Byte. This operation removes the activations of any status lines that are not authorized for control by the transmitting transcoder. The transcoder performs a logical AND operation between the received Command Byte and the I/O Assignment to get the Output Byte 1116. This operation only retains the activations of status lines that are set as outputs. If Latch mode is not enabled 1118, then the transcoder outputs the Output Byte on the status lines 1122. If Latch mode is enabled 1118, then the transcoder performs a logical XOR (exclusive OR) operation on the Output Byte and the current logical states of the status line outputs 1120. The transcoder then outputs the resulting Output Byte on the status line outputs 1122. If the transcoder is in Open Reception mode 1124, then the transcoder outputs the received address, the received Command Byte, and any received custom data 1126 on the SER_IO line. If the transcoder is not in Open Reception mode 1124, then the transcoder outputs the transmitting transcoder ID, the received Command Byte, and any received custom data 1128 on the SER_IO line. If the automatic confirmation is not enabled 1130, then the transcoder resets the RX Mode timer 1142 and loops back to check for any more valid data packets 1102. If the automatic confirmation is enabled 1130, then the transcoder pulls the TR_SEL line high 1132 to place the transceiver into transmit mode and makes the TR_DATA line an output 1134 so that the transcoder can send data to the transceiver. The transcoder outputs the confirmation packet 1136 on the TR_DATA line, pulls the TR_SEL line low 1138 to place the transceiver into receive mode, and makes the TR_DATA line an input 1140 so that it can get data from the transceiver. The transcoder resets the RX Mode timer 1142 and loops back to look for more packets 1102.

If no valid data packets are found 1102, a received address is not allowed to activate the transcoder 1106, or the received target address does not match the local address 1110, then the transcoder checks to see if the RX Mode timer has expired 1144. If the timer has expired, then the transcoder exits the mode 1146, otherwise it loops back and looks for more data packets 1102.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. An apparatus operable to perform the combined functions of a remote control encoder and decoder.

2. The apparatus of claim 1, comprising one or more status I/O lines, the apparatus being operable to set an address by randomizing a number based on a time that a status I/O line is held in a predetermined electrical state.

3. The apparatus of claim 1, comprising one or more status I/O lines, the direction of the status I/O lines being operable to be dynamically programmable.

4. The apparatus of claim 1, further comprising a memory, the apparatus being operable to learn an address of another transcoder apparatus that is operable to perform the combined functions of a remote control encoder and decoder, and operable to store a list of authorized addresses in the memory.

5. (canceled)

6. The apparatus of claim 1, further comprising one or more status I/O lines and a memory operable to store a set of control permissions for each user, wherein the set of control permissions determine how the apparatus responds to the reception of a valid command, either allowing or not allowing the activation of one or more of the one or more status I/O lines.

7. The apparatus of claim 1, being operable for affecting an automatic confirmation transmission in response to a command transmission.

8. (canceled)

9. The apparatus of claim 14, comprising a memory, the transcoder being operable to set individual output lines as latched or momentary based on a mask which may be set by a user and stored in the memory.

10. (canceled)

11. The apparatus of claim 14, being operable to output an identification of the transcoder.

12-13. (canceled)

14. A transcoder operable to function as an encoder and decoder, the transcoder comprising one or more status line inputs and status line outputs, the transcoder operable to target another transcoder so that only a targeted transcoder will respond to a command transmission.

15. The apparatus of claim 14, being operable to send custom, user defined data.

16-19. (canceled)

20. A method of operating a system comprising a first transcoder and a second transcoder, each of the first transcoder and second transcoder operable to function as an encoder and decoder, each of the first transcoder and second transcoder comprising a memory, one or more status I/O lines, a data transmission I/O line, each of the first transcoder and second transcoder being operable to generate a command data packet representative of electrical states of the status line inputs, the method comprising:
recording the electrical state of first status I/O lines that are programmed to be status line inputs as binary data;
combining the binary data with a unique identifier to form a command data packet; and
encoding the command data packet for security such that only another transcoder that is provided with a correct means is able to decode and validate the binary data contained in the command data packet.

21. The method of claim 20, further comprising:
creating an address including reading a current address stored in memory on the first transcoder;
running a randomizing algorithm for a time that an input is held in a first state; and
writing to the memory the resulting address when the input is held in a second state.

22. (canceled)

23. The method of claim 20, further comprising:
associating the first transcoder with the second transcoder by holding a status I/O line programmed as line an input in a first state on the second transcoder to place it into a learn mode;
sending a command data packet comprising an address associated with the first transcoder from the first transcoder and received by the second transcoder; and
storing the received address in memory on the second transcoder.

24. The method of claim 20, further comprising:
pulling a transceiver control line referred to as the TR_PDN line to a first state to activate an external transceiver;
starting a timer in the second transcoder;
checking the logic state of one of its input lines, referred to as the CRT/LRN line;
saving the received address in memory if the CRT/LRN line is held in a first state;
checking for valid packets by the second transcoder if the CRT/LRN line is held in a second state;
checking to see if the timeout timer has expired by the second transcoder on the second transcoder if there are no valid packets;
checking to see if the packet is intended for the second transcoder by the second transcoder if there are valid packets;
checking to see if the target address matches its local address by the second transcoder if the packet is targeted;
checking to see if the target address matches its local address by the second transcoder if the target address does not match;
checking to see if the timeout timer has expired;
saving and updating the control permissions if the target address matches or if the packet is not targeted;
checking to see if the automatic confirmation is enabled and, if so, pulling a transceiver control line referred to as the TR_SEL line to a first state to place an external transceiver into transmit mode;
making the TR_DATA line an output so that it can send data packets to the transceiver;
outputting a confirmation packet on the TR_DATA line;
pulling the TR_SEL line to a second state to place the transceiver into receive mode;
making the TR_DATA line an input so that it can receive data from the transceiver;
checking to see if the timeout timer has expired;
looping back to check if the CRT/LRN line is in the first state if not;
saving the received address in memory if the timeout timer has expired; and
saving by the transcoder all activated status lines as the control permissions.

25-29. (canceled)

30. The method of claim 20, wherein the transcoder being in electrical communication with a transceiver, further comprising a method of sending a transmission comprising:
pulling a TR_PDN line to a first state to turn on the transceiver;
pulling a TR_SEL line to a first state to place the transceiver into transmit mode;
making a TR_DATA line an output so that it can send data to the transceiver;
checking, by the transcoder, the logic state of the status line inputs;
creating the command byte;
reading, by the second transcoder, the local address, target address, and custom data value from memory;
assembling the data packet consisting of a preamble, a local Address, and a Command Byte;
adding, by the second transcoder, the target address to the data packet if targeting is enabled;
checking to see if custom data is enabled if targeting is not enabled;
adding, by the second transcoder, the custom data value to the data packet if custom data is enabled;
outputting the data packet on the TR_DATA line if custom data is not enabled;
pulling, by the transcoder, the TR_SEL line to a second state to place the transceiver into receive mode;
making the TR_DATA line an input;
starting a timer;
waiting in a loop, by the second transcoder, until either the timer times out or a valid confirmation data packet is received;
pulling, by the transcoder, the TR_SEL line to a first state to place the transceiver into transmit mode and making the TR_DATA line an output so that it can send data to the transceiver when the timer times out;
checking, by the second transcoder, to see if any status line inputs are in the first state;
getting, by the second transcoder, the command byte and starting the loop again if any status line inputs are in the first state;
exiting the mode if no status line inputs are high;
pulling, by the second transcoder, the TR_SEL line to the first state to place the transceiver into transmit mode and making the TR_DATA line an output so that it can send data to the transceiver if a valid confirmation packet is received;
pulling, but buy the second transcoder, the CONFIRM line to the first state, resetting the timer, and checking to see if any status line inputs are high if the confirmation is valid;
getting the command byte and starting the loop again if any status line inputs are in the first state; and
exiting the mode if no status line inputs are in the first state.

31. The method of claim 20, further comprising:
looking, by the second transcoder, for any valid data packets;
checking, by the second transcoder, to see if a RX Mode timer has timed out if no valid data packets are received;
checking, by the second transcoder, to see if the second transcoder is in Open Reception mode if the transcoder receives valid data packets;
skipping checking to see if the address is authorized if the second transcoder is in Open Reception mode;
checking to see if the received address is in memory on the second transcoder and is authorized to activate the second transcoder if the second transcoder is not in Open Reception mode;
checking to see if a RX Mode timer has timed out if the address is not authorized;
checking to see if received data packet is a targeted packet intended for the second transcoder;
checking to see if a second transcoder local address matches a target address in a received data packet if the data packet is targeted;
checking to see if the RX Mode timer has timed out if the received target address does not match the local address;
making a SER_IO line an output and pulling it to a first state if the received data packet is not targeted, or if the local address matches the target address;
performing a logical AND operation with the Command Byte and the Control Permissions to get the Control Byte, thereby removing the activations of any status lines that are not authorized for control by the first transcoder;
performing a logical AND operation between the received Command Byte and the I/O Assignment to get the Output Byte;
outputting the Output Byte on the status lines if Latch mode is not enabled;
performing a logical XOR (exclusive OR) operation on the Output Byte and the current logical states of the status line outputs if Latch mode is enabled;
outputting the resulting Output Byte on the status line outputs;
outputting the received address, the received Command Byte, and any received custom data on the SER_IO line if the second transcoder is in Open Reception mode;
outputting the first transcoder ID, the received Command Byte, and any received custom data on the SER_IO line if the second transcoder is not in Open Reception mode;
resetting the RX Mode time and looping back to check for any more valid data packets if the automatic confirmation is not enabled;
pulling the TR_SEL line to a first state to place the transceiver into transmit mode and making the TR_DATA line an output so that the first transcoder can send data to the transceiver if the automatic confirmation is enabled;
outputting the confirmation packet on the TR_DATA line, pulling the TR_SEL line to a second state to place the transceiver into receive mode, and making the TR_DATA line an input such that it can get data from the transceiver;
resetting the RX Mode timer and looping back to look for more packets;
disallowing a received address to activate the second transcoder if no valid data packets are found or the received target address does not match the local address;
checking, by the second transcoder, to see if the RX Mode timer has expired;
exiting the mode; and
looping back and looking for more data packets if the timer has not expired.

32. (canceled)

33. The apparatus of claim 65, further comprising:
a switch unit;
an encoder including one or more encoder input lines in electrical communication with the switch unit; and
a first transceiver in electrical communication with the encoder, the switch unit including one or more switches operable for providing an open or closed electrical state to the encoder communicated via an encoder input line, the encoder being operable to generate a data packet representative of that electrical state, the encoder operable to communicate the command data packet to the first transceiver, the first transceiver being operable to affect wireless transmission of the command data packet.

34-41. (canceled)

42. The apparatus of claim 1, further comprising:
a switch unit;
a transcoder; and
a transceiver, the transcoder comprising one or more status line inputs in electrical communication with the switch unit and one or more status line outputs operable for electrical communication with application circuitry, the transcoder and transceiver in electrical communication by a data transmission I/O line, the switch unit comprises one or more switches in electrical communication with the status line inputs, the switches operable for providing an open or closed electrical state to the transcoder communicated via respective status line inputs, the transcoder being operable to generate a command data packet representative of the electrical states of the status line inputs, the transceiver is operable to affect wireless transmission of the command data packet to another transceiver, the transceiver operable to receive and communicate a wireless transmission of a command data packet to the transcoder, the transcoder being operable to control application circuitry based on a received command data packet.

43. The apparatus of claim 1, comprising a first transcoder product and a second transcoder product, the first transcoder product comprising:
a first switch unit;
a first transcoder; and
a first transceiver, the first transcoder comprising one or more first status line inputs in electrical communication with the first switch unit and one or more first status line outputs operable for electrical communication with first application circuitry, the first transcoder and first transceiver in electrical communication by a first data transmission I/O line, the first switch unit comprising one or more switches in electrical communication with the first status line inputs, the switches operable for providing an open or closed electrical state to the first transcoder communicated via respective status line inputs, the first transcoder being operable to generate a command data packet representative of the electrical states of the first status line inputs,
the second transcoder product comprising:
a second switch unit;
a second transcoder; and
a second transceiver, the second transcoder comprising one or more second status line inputs in electrical communication with the second switch unit and one or more second status line outputs operable for electrical communication with second application circuitry, the second transcoder and second transceiver in electrical communication by a second data transmission I/O line, the second switch unit comprising one or more switches in electrical communication with the second status line inputs, the switches operable for providing an open or closed electrical state to the second transcoder communicated via respective status line inputs, the second transcoder being operable to generate a command data packet representative of the electrical states of the second status line inputs,
the first transceiver being operable to affect wireless transmission of the command data packet to the second transceiver, the second transceiver operable to receive and communicate the wireless transmission of the command data packet to the second transcoder, the second transcoder being operable to control second application circuitry based on the received command data packet.

44-64. (canceled)

65. The method of claim 20 further comprising:
programming the status I/O lines to be status line outputs on the second transcoder that are set to replicate the electrical state of the status line inputs on the first transcoder upon successful recovery and validation of the binary data from the command data packet.
